(19) United States
(12) Patent Application Publication
(10) Pub. No.: US 2024/0343337 A1
(43) Pub. Date: Oct. 17, 2024

(54) CONTROL DEVICE AND METHOD OF A BICYCLE AUTOMATIC SHOCK ABSORBER

(71) Applicant: Ming-Ta Tsai, NEW TAIPEI CITY (TW)

(72) Inventor: Ming-Ta Tsai, NEW TAIPEI CITY (TW)

(21) Appl. No.: 18/752,797

(22) Filed: Jun. 25, 2024

Related U.S. Application Data
(63) Continuation-in-part of application No. 17/883,637, filed on Aug. 9, 2022.

(51) Int. Cl. B62K 25/04; B62J 45/20; B62J 45/41

(52) U.S. Cl. CPC B62K 25/04; B62J 45/20; B62J 45/41; B62K 2025/044

(57) ABSTRACT

A control device and method of a bicycle automatic shock absorber are provided. The device includes a shock absorbing module and a controller. The shock absorbing module has a control unit electrically connected to a shock absorbing mode unit, a sensing unit, a damping unit and a first wireless transmission unit. The controller is electrically connected to a pressing unit, a second wireless transmission unit and a manual switching unit. The shock absorbing mode unit 12 has an automatic shock absorbing mode 120 and a manual shock absorbing mode 121. The control device for a bicycle automatic shock absorber provides an option of automatically adjusting the damping of the shock absorber according to road conditions through the wireless connection between the shock absorber module and the controller or manually adjust the damping of the shock absorber through the controller.

### FIELD OF THE DISCLOSURE

The present disclosure relates to a control device and a method of a bicycle automatic shock absorber, and more particularly to a shock absorbing device and a method that can change the damping effect according to road conditions.

### BACKGROUND OF THE DISCLOSURE

Shock absorbers used in bicycles, such as the front fork shock absorbers can be found as disclosed in TWM602994, entitled “Bicycle air pressure shock absorber,” TWM536300, entitled “air shock absorber,” CN209067742U, entitled “rebound damping for bicycle,” TWI413601, entitled “Spring suspension for a handlebar-steered vehicle,” U.S. Pat. No. 10,668,975B2, entitled “Shock device in particular for bicycles” and U.S. Pat. No. 10,337,584B2, entitled “Bicycle fork having lock-out, blow-off, and adjustable blow-off threshold.” The conventional arts show the different types of shock absorbers individually used or in combination of air pressure, oil pressure, and/or spring, etc.

However, the damping effect of the above shock absorbers is adjusted according to the rider, the type of bicycle (such as a single shock absorber bicycle or a double shock absorbers bicycle), and the road conditions (country roads, industrial roads, or forest roads), and is trouble to operate, and even requires additional tools for adjustment. Accordingly, it is not simple and easy to adjust for ordinary cyclists. During non-competition, cyclists do not frequently adjust the fine-tuning of the front fork damping, so that the shock absorber with adjustment function or the above-mentioned patented products are not able to perform at its maximum effectiveness.

### SUMMARY OF THE DISCLOSURE

The present disclosure provides a control device and a method of a bicycle automatic shock absorber. The main purpose of the present disclosure is to provide the user with the option of automatically adjusting the damping of the shock absorber according to road conditions through the wireless connection between the shock absorber module and the controller, or to choose to manually adjust the damping of the shock absorber through the controller.

The control device of a bicycle automatic shock absorber of the present disclosure, includes a shock absorbing module, mounted on a bicycle shock absorber and provided with a control unit; wherein the control unit is electrically connected to a shock absorbing mode unit, a sensing unit, a damping unit, and a first wireless transmission unit; and a controller, mounted on the bicycle tube and including and electrically connected to a pressing unit, a second wireless transmission unit, and a manual switching unit; wherein the controller wireless connects with the first wireless transmission unit of the shock absorbing module through the second wireless transmission unit. wherein when the shock absorbing module is successfully paired with the controller, the shock absorbing mode unit executes the automatic shock absorbing mode, and the sensing unit transmits a sensing signal to the damping unit, so that the damping unit adjusts the damping response of the bicycle shock absorber; wherein when the pressing unit transmits a second pressing signal to the shock absorbing mode unit, then the shock absorbing mode unit executes the manual shock absorbing mode. The manual switching unit transmits a switch signal to the damping unit, so that the damping unit adjusts the damping response of the bicycle shock absorber.

### BRIEF DESCRIPTION OF THE DRAWINGS

The described embodiments may be better understood by reference to the following description and the accompanying drawings in which:

FIG. 1 is a block schematic diagram of the present disclosure;

FIG. 2 is a schematic perspective view of the control device of a bicycle automatic shock absorber of the present disclosure applied to the bicycle front fork;

FIG. 3 is a schematic perspective view of the controller being fittingly engaged with the first case;

FIG. 4 is a schematic perspective view of another angle of the controller being fittingly engaged with the first case;

FIG. 5 is a schematic perspective view of the bottom view of the controller being fittingly engaged with the first case;

FIG. 6 is a sectional schematic view of VI-VI in FIG. 2, in which the front fork is locked;

FIG. 7 is a partially enlarged schematic view of A in FIG. 6;

FIG. 8 is a partially enlarged schematic view of B in FIG. 6, wherein the end of the stem closes the flow channel (the hard shock absorbing mode);

FIG. 9 is a schematic view of the end of the stem near the flow channel (the balanced shock absorbing mode);

FIG. 10 is a schematic view of the end of the valve stem away from the flow channel (the soft shock absorbing mode);

FIG. 11 is a schematic view of the control unit including an automatic shock absorbing mode, a manual shock absorbing mode, a soft shock absorbing mode, a balanced shock absorbing mode, and a hard shock absorbing mode;

FIG. 12 is a schematic view of changing the damping effect of the bicycle shock absorber when the acceleration changes in the automatic shock absorbing mode of the present disclosure;

FIG. 13 is a schematic view of the fixed controller and the portable device mounted on the bicycle;

FIG. 14 is a schematic view of the operation interface of the portable device;

FIG. 15 is a flowchart of the method of the present disclosure; and

FIG. 16 is a block diagram of the shock absorber module, the controller, the seat post lifting module, and the anti-theft alert module of the present invention.

### DETAILED DESCRIPTION OF THE EXEMPLARY EMBODIMENTS

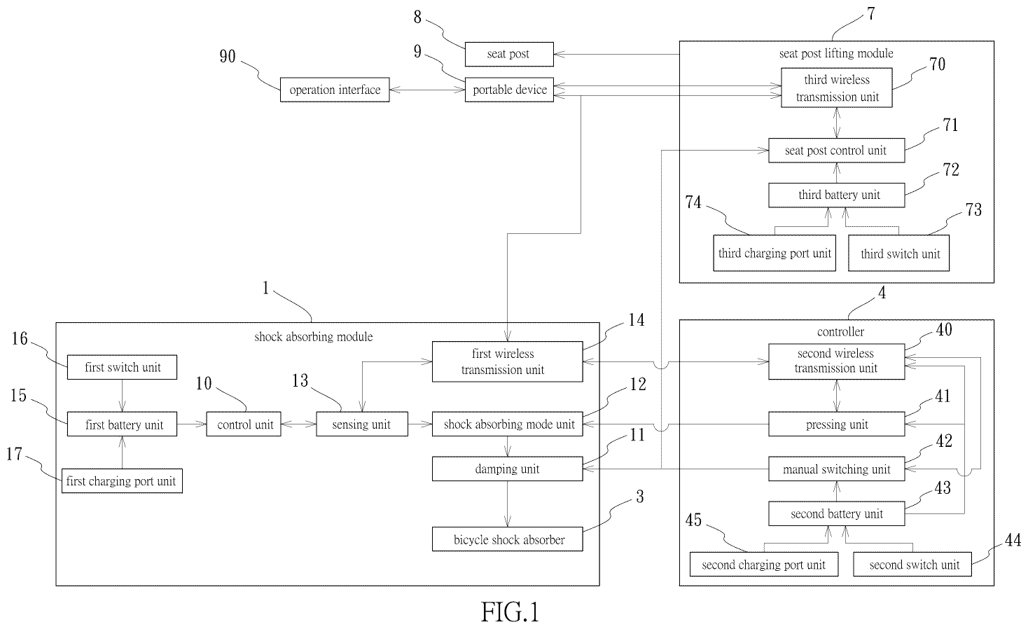

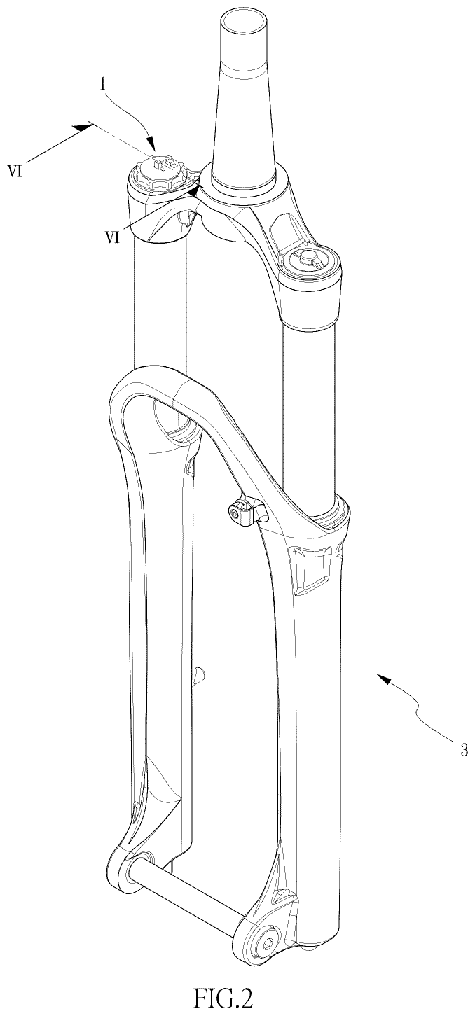

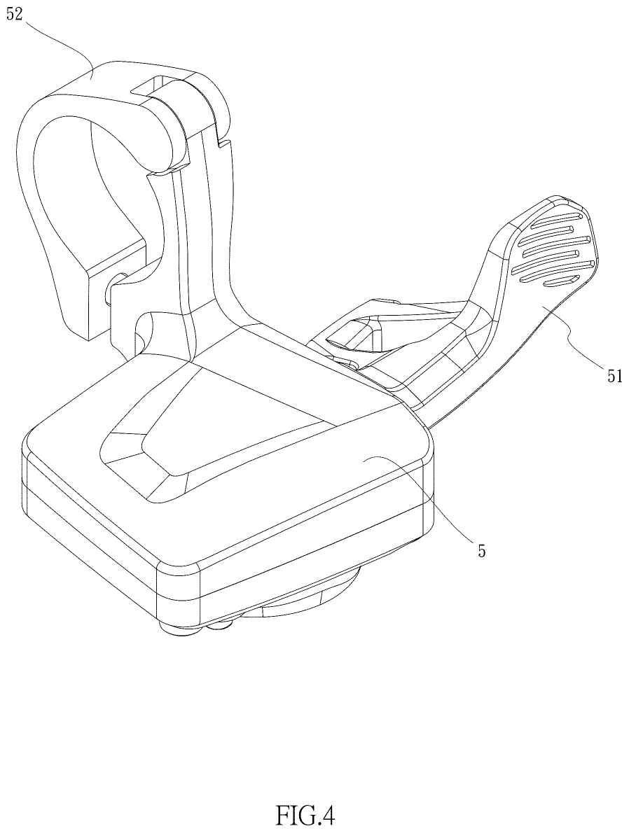

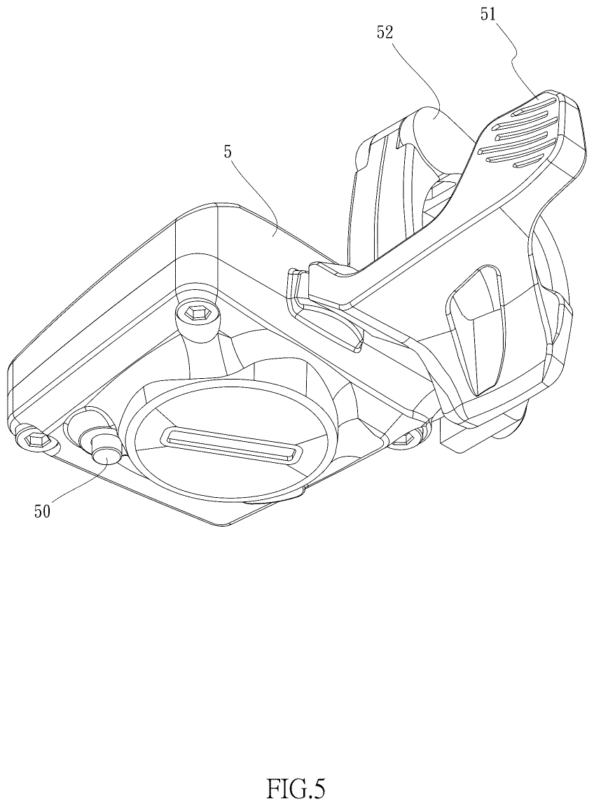

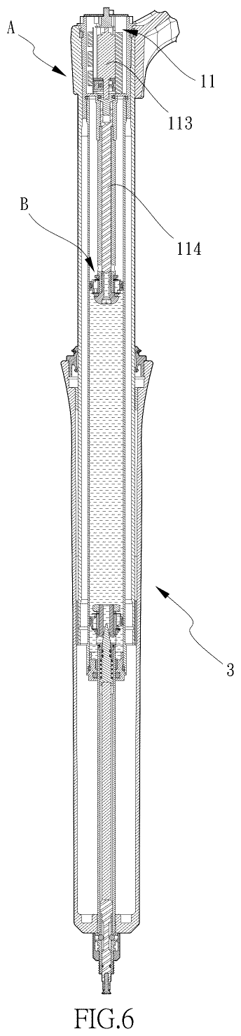

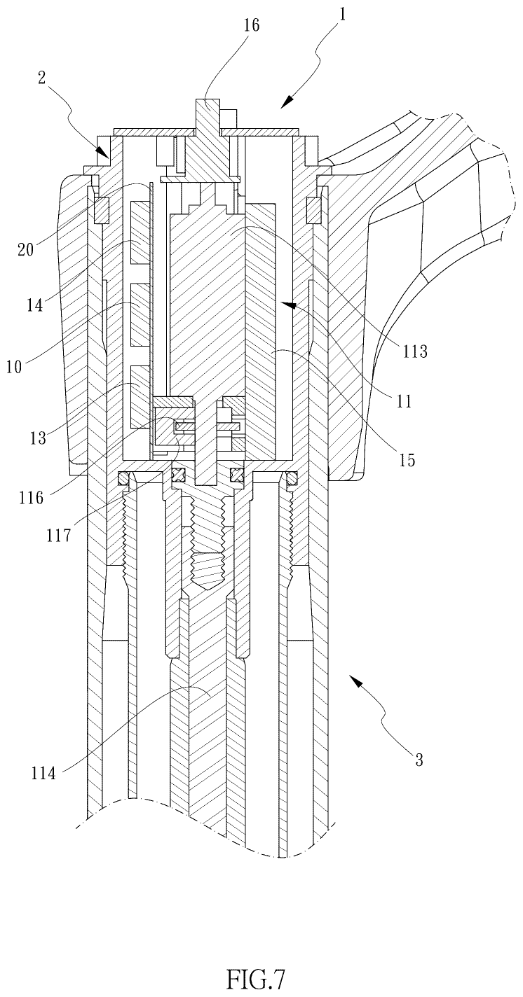

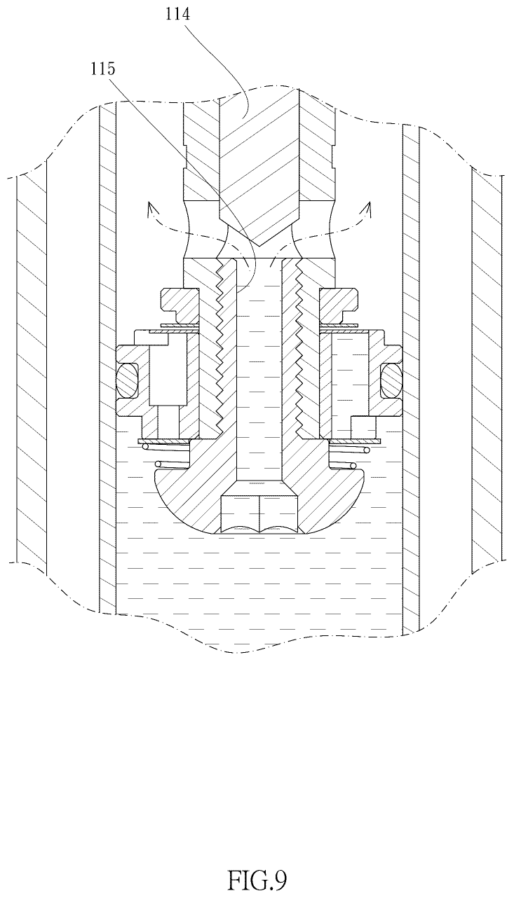

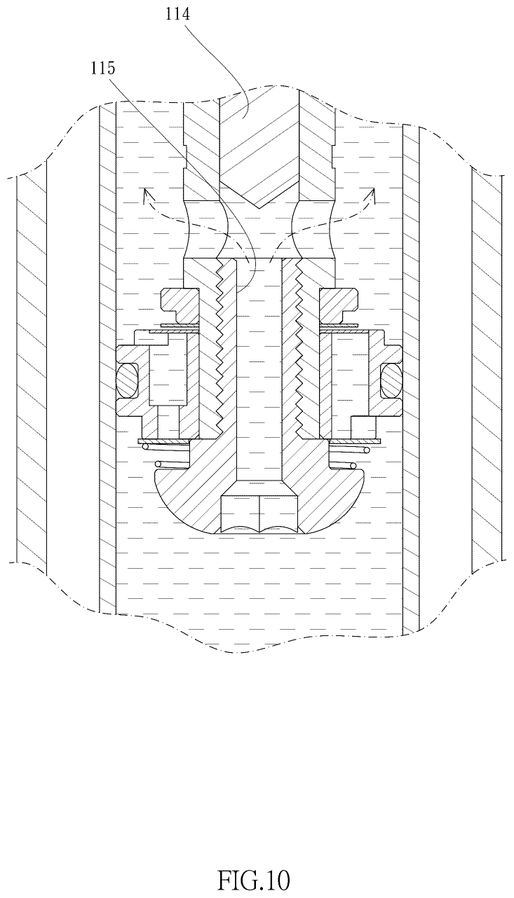

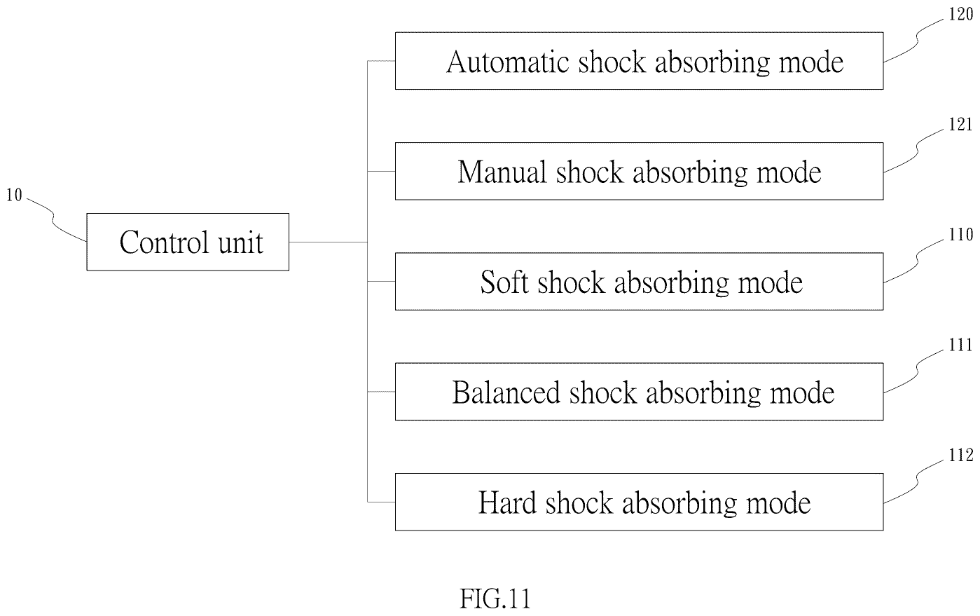

Referring to FIGS. 1-16, the control device of a bicycle automatic shock absorber of the present disclosure includes a shock absorbing module 1 and a controller 4.

The shock absorbing module 1 is mounted on a bicycle shock absorber 3 through a cover 2 and provides a control unit 10, the cover 2 has a circuit board 20 electrically connected to the control unit 10. The control unit 10 is electrically connected to a damping unit 11, a shock absorbing mode unit 12, a sensing unit 13 and a first wireless transmission unit 14, and a first battery unit 15.

In one embodiment of the present disclosure, the damping unit 11 includes a soft shock absorbing mode 110, a balanced shock absorbing mode 111, and a hard shock absorbing mode 112. The shock absorbing mode unit 12 has an automatic shock absorbing mode 120 and a manual shock absorbing mode 121. The sensing unit 13 is an accelerometer, also known as an acceleration sensor, and a gravitational acceleration sensor. The first battery unit 15 supplies electricity to the shock absorbing module 1.

The controller 4 is mounted on the bicycle tube 6 through a first case 5. The first case 5 has an automatic button 50 and a paddle 51. The controller 4 includes and is electrically connected to a second wireless transmission unit 40, a pressing unit 41, a manual switching unit 42, and a second battery unit 43; wherein the controller 4 wireless connects with the first wireless transmission unit 14 of the shock absorbing module 1 through the second wireless transmission unit 40.

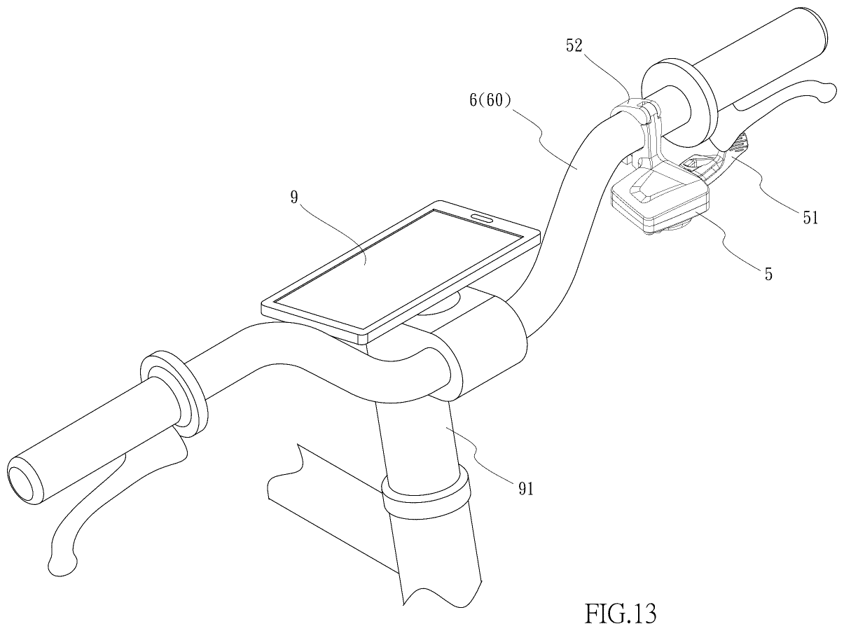

In one embodiment of the present disclosure, the automatic button 50 is electrically connected to the pressing unit 41, and the paddle 51 is electrically connected to the manual switching unit 42. The second battery unit 43 provides electricity to the controller 4. The first case 5 further includes a fixed ring 52, the first case 5 is fixed on the bicycle handle 60 through the fixed ring 52 (as shown in FIG. 13).

Further, the present disclosure further includes a seat post lifting module 7 installed on a seat post 8 and having a third wireless transmission unit 70, a seat post control unit 71, and a third battery unit 72. Furthermore, the seat post lifting module 7 is wirelessly connected to the second wireless transmission unit 40 of the controller 4. In one embodiment of the present disclosure, the seat post control unit 71 receives the seat post adjusting signal transmitted by the manual switching unit 42 of the controller 4 to adjust the seat post 8.

Moreover, the shock absorbing module 1 includes a first battery unit 15 and a first switch unit 16 electrically connected to the first battery unit 15, the controller 4 includes a second battery unit 43 and a second switch unit 44 electrically connected to the second battery unit 43, the seat post lifting module 7 includes a third battery unit 72 and a third switch unit 73 electrically connected to the third battery unit 72. Therefore, the shock absorbing module 1, the controller 4, and the seat post lifting module 7 can be controlled and switched.

Moreover, the shock absorbing module 1 includes a first charging port unit 17 electrically connected to the first battery unit 15, the controller 4 includes a second charging port unit 45 electrically connected to the second battery unit 43, the seat post lifting module 7 includes a third charging port unit 74 electrically connected to the third battery unit 72. Through the first charging port unit 17, the second charging port unit 45, and the third charging port unit 74, the first battery unit 15, the second battery unit 43, and the third battery unit 72 can be charged respectively with an external power supply.

In one embodiment of the present disclosure, the first charging port unit 17, the second charging port unit 45, and the third charging port unit 74 are in the form of a USB connector.

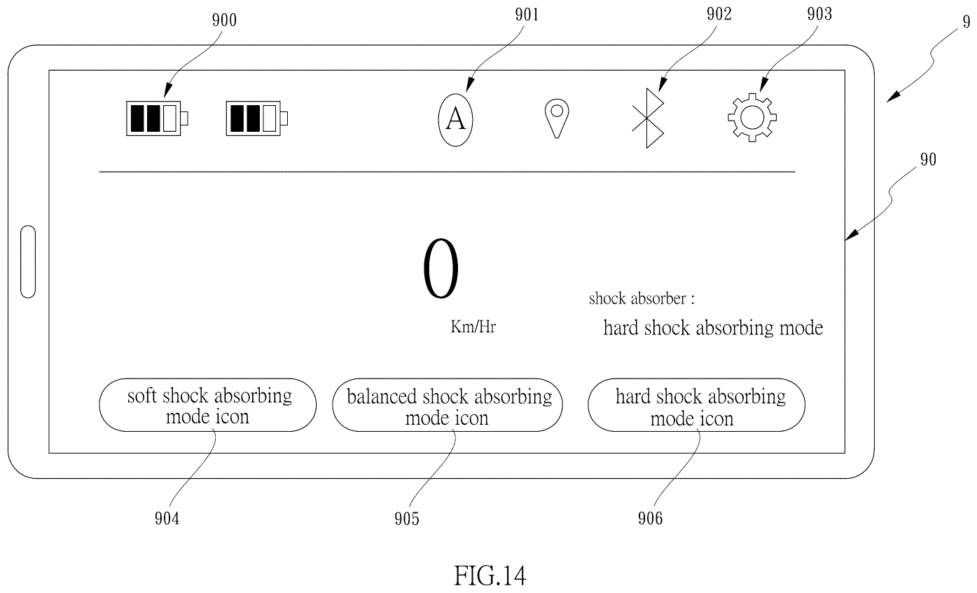

In addition, the present disclosure further includes a portable device 9, including an operation interface 90, and the operation interface 90 includes a control battery power status bar 900, an automatic shock absorbing mode icon 901, a wireless icon 902, a setting icon 903, a soft shock absorbing mode icon 904, a balanced shock absorbing mode icon 905, and a hard shock absorbing mode icon 906, as shown in FIG. 14. The aforementioned portable device 9 can be a mobile device, such as a smartphone or a tablet, and the operation interface 90 is a software program such as an APP (Application) downloaded by the portable device 9 through the Internet and installed on the portable device 9 and can be executed. The portable device 9 is installed on a bicycle stem 91, as shown in FIG. 13. The portable device 9 provides the user with another option to operate the device, and the operation interface 90 includes the automatic shock absorbing mode icon 902, the soft shock absorbing mode icon 905, the balanced shock absorbing mode icon 906, the hard shock absorbing mode icon 907 for manually selecting the appropriate damping effect. The battery power status bar 900 shows the current remaining power of the battery. The wireless icon 903 provides on-and-off operation of the wireless communication of the portable device 9.

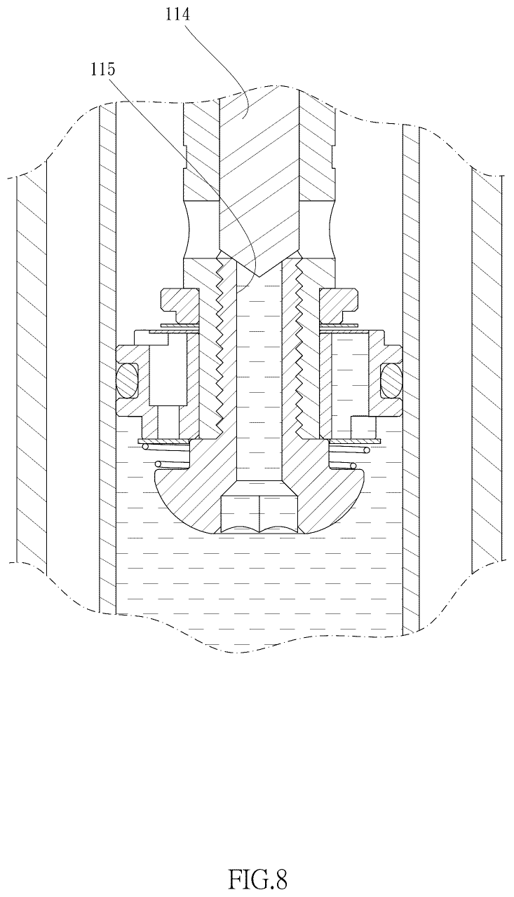

Regarding the damping adjustment of the bicycle shock absorber 3, which can be read in conjunction with FIGS. 8-10, the motor 113 of the damping unit 11 operates and indirectly drives the valve stem 114 to move along the axial direction of the front fork, so that the end of the valve stem 114 changes in locations such as closing the flow channel 115, near the flow channel 115, and away from the flow channel 115. The location of the end of the valve stem 114 leads to blocked fluid flow, restricted fluid flow (blocked by the end of the valve stem 114), and smooth fluid flow (unblocked by the end of the stem 220), which forms the front fork lock state (corresponding to the hard shock absorbing mode 112), the front fork relaxation state (corresponding to the balanced shock absorbing mode 111), and the unlocking state (corresponding to the soft shock absorbing mode 110) respectively. The move distance of the valve stem 114 can be driven by the motor 113 when the vane 116 rotates, and the photo-interrupter 117 senses the number of revolutions of the vane 116 to convert the move distance of the valve stem 114 to close the flow channel 115, near the flow channel 115, or away from the flow channel 115, thereby forming the compression damping effect of the bicycle shock absorber 3.

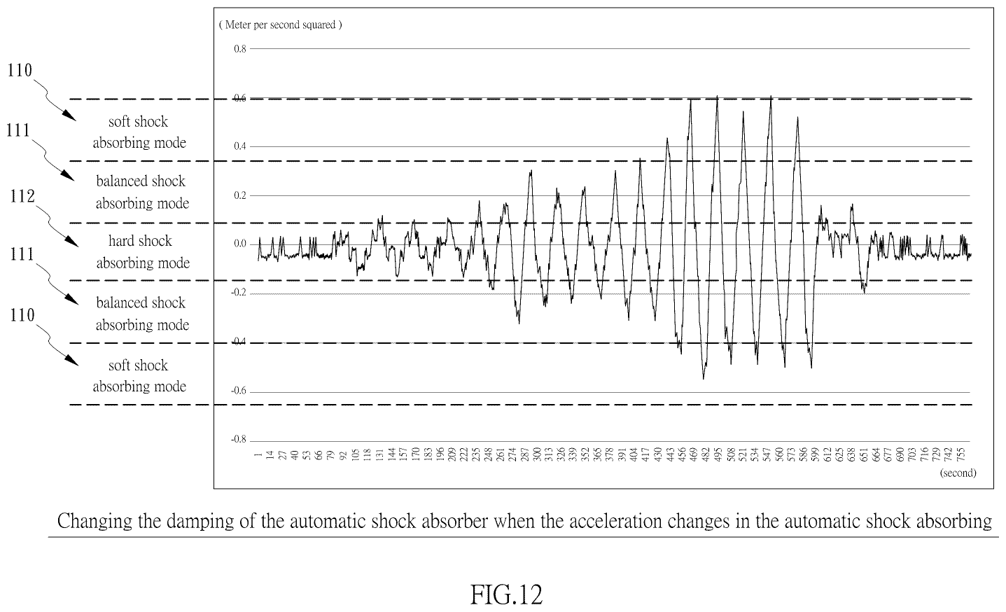

Therefore, when the shock absorbing mode unit 12 executes the automatic shock absorbing mode 120 (as shown in FIG. 12), the left longitudinal axis is the acceleration (m/s²), and the lower lateral axis is the elapsed time (sec). Further, FIGURES shows five lateral sections, and the middle section shows an acceleration from 0.1 m/s² to −0.18 m/s², the damping effect of the bicycle shock absorber 3 being adjusted to the hard shock absorbing mode 112. Furthermore, the sections between the middle section and the outer section show an acceleration from −0.18 m/s² to −0.4 m/s² and from 0.18 m/s² to 0.38 m/s², the damping effect of the bicycle shock absorber 3 is adjusted to the balanced shock absorbing mode 111. The outer sections show an acceleration from −0.4 m/s² to −0.62 m/s² and from 0.38 m/s² to −0.6 m/s² the damping effect of the bicycle shock absorber 3 being adjusted to the soft shock absorbing mode 110.

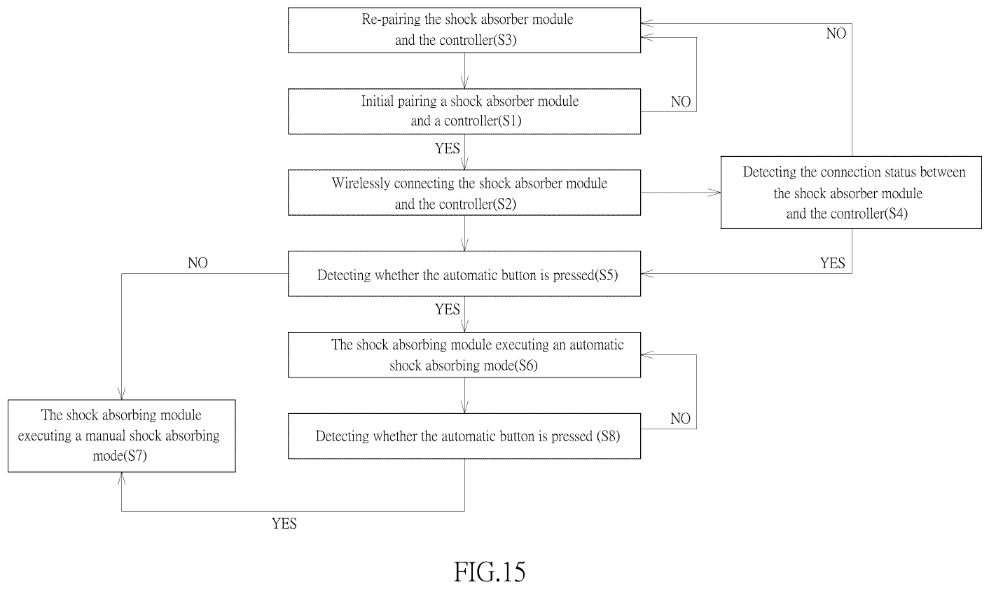

Referring to FIG. 15, the control method to wireless control a bicycle automatic shock absorber of the present disclosure is provided. A shock absorber module 1 and a controller 4 are provided for an initially pairing, and after that subsequent steps can be executed. The method includes:
step S1: initially pairing a shock absorber module 1 and a controller 4, proceeding to step S2 if the pairing is successful (YES), otherwise (if the pairing is unsuccessful, NO) proceeding to step S3;
step S2: wirelessly connecting the shock absorber module 1 and the controller 4 and proceeding to step S4;
step S3: re-pairing the shock absorber module 1 and the controller 4 until the pairing is successful and proceeding to the step S2;
step S4: detecting the connection status between the shock absorber module 1 and the controller 4 at any time, proceeding to step S5 if the connection status is connected (YES), otherwise (if the connection status is disconnected, NO) returning to step S3;
step S5: detecting whether the automatic button 50 of the controller 4 is pressed, proceeding to step S6 if the automatic button 50 is pressed (YES), otherwise (if the automatic button 50 is not pressed, NO) proceeding to step S7;
step S6: the shock absorbing mode unit 12 of the shock absorbing module 1 executing an automatic shock absorbing mode 120; wherein the sensing unit 13 automatically senses the vibration of the bicycle and transmits a sensing signal to the control unit 10, then the control unit 10 transmits a control signal to the damping unit 11, so that the damping unit 11 adjusts the damping of the bicycle shock absorber 3;
step S7: the shock absorbing mode unit 12 of the shock absorbing module 1 executing a manual shock absorbing mode 121, the user adjusts the paddle 51 manually according to riding conditions, so that the manual switching unit 42 transmits a switch signal to the damping unit 11, and the damping unit 11 adjusts the damping of the bicycle shock absorber 3; and
step S8: detecting whether the automatic button 50 is pressed again, the shock absorbing module 12 continuing to execute step S6 (automatic shock absorbing mode 120) if the automatic button 50 is not pressed again (NO), the shock absorbing module 12 exiting the automatic shock absorbing mode 120 and returning to proceed step S7 if the automatic button 50 is pressed again (YES).

In operation, when the shock absorbing module 1 is successfully paired with the controller 4, through pressing the pressing unit 50, the pressing unit 41 transmits a first pressing signal through the second wireless transmission unit 40 to the first wireless transmission unit 14, and the first wireless transmission unit 14 transmits the first pressing signal to the shock absorbing mode unit 12. The shock absorbing mode unit 12 executes the automatic shock absorbing mode 120. The sensing unit 13 detects the shock impact during riding (the front fork telescopic operation direction is defined as the detection and judgment direction, and the acceleration of the aforementioned vibration is m/s2) and transmits a sensing signal to the control unit 10. The control unit 10 transmits a control signal to the damping unit 11, so that the damping unit 11 adjusts the damping response of the bicycle shock absorber 3.

Moreover, the user can press the automatic button 50 again, when the pressing unit 41 transmits a second pressing signal through the second wireless transmission unit 40 to the first wireless transmission unit 14. The first wireless transmission unit 14 transmits the second pressing signal to the shock absorbing mode unit 12, then the shock absorbing mode unit 12 switches from the automatic shock absorbing mode 120 to the manual shock absorbing mode 121. The user adjusts the paddle 51 manually, so that the manual switching unit 42 transmits different switch signals to the damping unit 11, and the damping unit 11 switches the different shock absorbing modules.

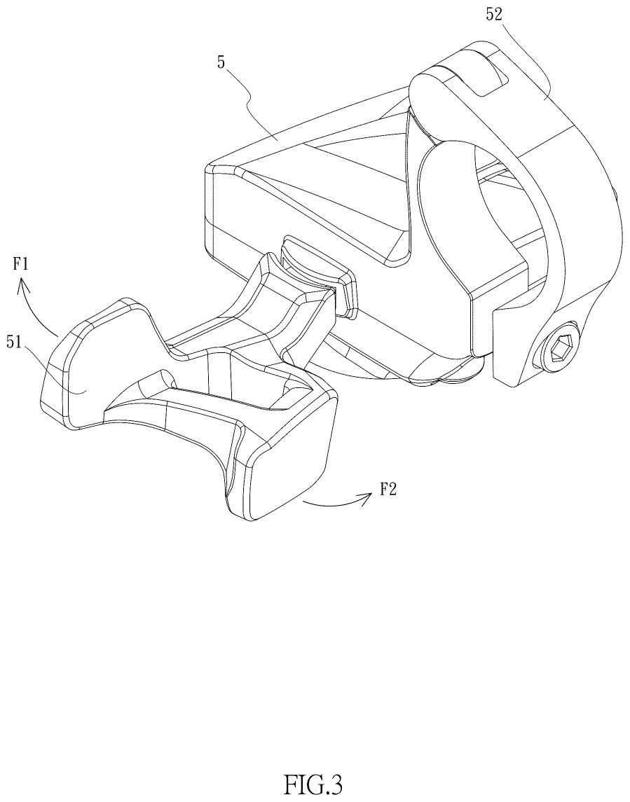

For example, as shown in FIG. 3. When the user adjusts the paddle 51 in the first direction F1 for the first time, the manual switching unit 42 receives a first switch signal, and the damping unit 11 executes the soft shock absorbing mode 110. When the user adjusts the paddle 51 in the first direction F1 for the second time, the manual switching unit 42 receives a second switch signal, and the damping unit 11 executes the balanced shock absorbing mode 111. When the user adjusts the paddle 51 in the first direction F1 for the third time, the manual switching unit 42 receives a third switch signal, and the damping unit 11 executes the hard shock absorbing mode 112.

Accordingly, the user can manually adjust the damping unit 11 to perform different shock absorbing modes, and quickly adjust the damping effect of the bicycle shock absorber 3 in a simple manner, especially when the device is applied to known road conditions, such as paved roads, sandy and soil mixed roads or bumpy and rugged forest roads, appropriate manual control can be provided. In addition, the user can also make the seat post control unit 71 drive the seat post 8 to rise and fall by turning the paddle 51 in the second direction F2.

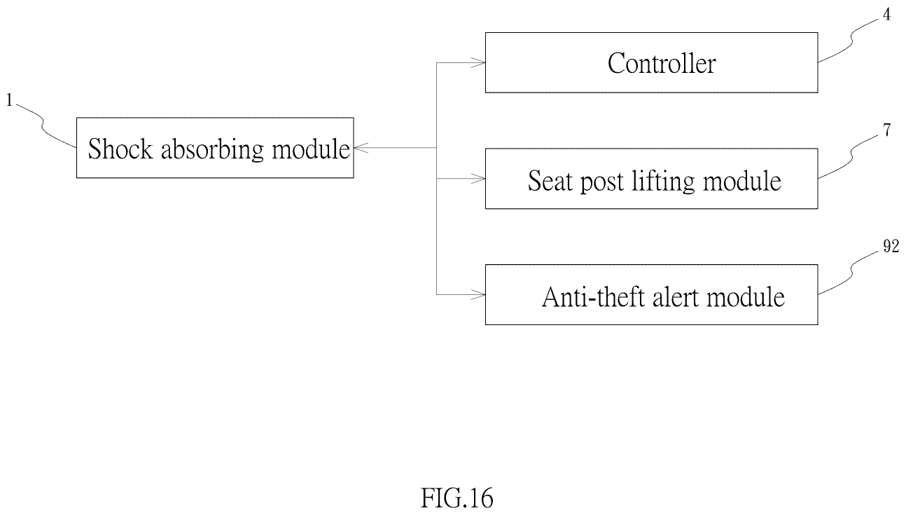

It is worth mentioning that the shock absorbing module 1 can further be connected wirelessly with the anti-theft alert module 92 (as shown in FIG. 16) for anti-theft use. For example, when a thief steals a bicycle, the sensing unit 13 senses the abnormal vibration of the bicycle, it will transmit an anti-theft signal to the control unit 10, then the control unit 10 transmits a warning signal to the alarm unit (not shown in the Figures) to make a sound, attracting the attention of people around, therefore, the anti-theft alert module 92 achieves the effect of warning and preventing stealing.

What is claimed is:

1. A control device of a bicycle automatic shock absorber, comprising:
a shock absorbing module 1, mounted on a bicycle shock absorber 3 and provided with a control unit 10; wherein the control unit 10 is electrically connected to a shock absorbing mode unit 12, a sensing unit 13, a damping unit 11 and a first wireless transmission unit 14, and the shock absorbing mode unit 12 has an automatic shock absorbing mode 120 and a manual shock absorbing mode 121; and
a controller 4, mounted on the bicycle tube 6 and including a pressing unit 41, a second wireless transmission unit 40, and a manual switching unit 42; wherein the pressing unit 41, the second wireless transmission unit 40, and the manual switching unit 42 are electrically connected to each other; wherein the controller 4 wireless connects with the first wireless transmission unit 14 of the shock absorbing module 1 through the second wireless transmission unit 40;
wherein when the shock absorbing module 1 is successfully paired with the controller 4, the pressing unit 41 transmits a first pressing signal to the shock absorbing mode unit 12, then the shock absorbing mode unit 12 executes the automatic shock absorbing mode 120, and the sensing unit 13 transmits a sensing signal to the control unit 10, then the control unit 10 transmits a control signal to the damping unit 11, so that the damping unit 11 adjusts the damping response of the bicycle shock absorber 3;
wherein when the pressing unit 41 transmits a second pressing signal to the shock absorbing mode unit 12, then the shock absorbing mode unit 12 executes the manual shock absorbing mode 121, and the manual switching unit 42 transmits a switch signal to the damping unit 11, so that the damping unit 11 adjusts the damping response of the bicycle shock absorber 3.

2. The control device of a bicycle automatic shock absorber according to claim 1, wherein the shock absorbing module 1 is fittingly engaged with a cover 2, the cover 2 has a circuit board 20 electrically connected to the control unit 10; wherein the controller 4 is fittingly engaged with a first case 5, the first case 5 includes an automatic button 50, a paddle 51 and a fixed ring 52; wherein the automatic button 50 is electrically connected to the pressing unit 41, and the paddle 51 is electrically connected to the manual switching unit 42; wherein the fixed ring 52 is fixed on the bicycle handle 60.

3. The control device of a bicycle automatic shock absorber according to claim 2, wherein the bicycle tube 6 is a bicycle handle 60.

4. The control device of a bicycle automatic shock absorber according to claim 1, wherein the damping unit 11 includes a soft shock absorbing mode 110, a balanced shock absorbing mode 111, and a hard shock absorbing mode 112.

5. The control device of a bicycle automatic shock absorber according to claim 1, further including a seat post lifting module 7 installed on a seat post 8 and having a third wireless transmission unit 70, a seat post control unit 71, and a third battery unit 72; wherein the seat post lifting module 7 wirelessly connected with the second wireless transmission unit 40 of the controller 4 through the third wireless transmission unit 70; wherein the third wireless transmission unit 70 of the seat post lifting module 7 receives the seat post adjusting signal transmitted by the manual switching unit 42 of the controller 4 through the second wireless transmission unit 40 to adjust the seat post 8.

6. The control device of a bicycle automatic shock absorber according to claim 5, wherein the shock absorbing module 1 includes a first battery unit 15 and a first switch unit 16 electrically connected to the first battery unit 15, the controller 4 includes a second battery unit 43 and a second switch unit 44 electrically connected to the second battery unit 43, the seat post lifting module 7 includes a third battery unit 72 and a third switch unit 73 electrically connected to the third battery unit 72.

7. The control device of a bicycle automatic shock absorber according to claim 5, wherein the shock absorbing module 1 includes a first charging port unit 17 electrically connected to the first battery unit 15, the controller 4 includes a second charging port unit 45 electrically connected to the second battery unit 43, the seat post lifting module 7 includes a third charging port unit 74 electrically connected to the third battery unit 72.

8. The control device of a bicycle automatic shock absorber according to claim 1, further including a portable device 9 installed on bicycle stem 91;
wherein the portable device 9 includes an operation interface 90, and the operation interface 90 includes a shock absorbing battery power status bar 900, a control battery power status bar 901, an automatic shock absorbing mode icon 902, a wireless icon 903, a setting icon 904, a soft shock absorbing mode icon 905, a balanced shock absorbing mode icon 906, and a hard shock absorbing mode icon 907.

9. The control device of a bicycle automatic shock absorber according to claim 1, further including an anti-theft alert module 92, the anti-theft alert module 92 is wirelessly connected to the shock absorbing module 1.

10. A control method of a bicycle automatic shock absorber, comprising:
step S1: providing a shock absorber module 1 and a controller 4 for an initial pairing, proceeding to step S2 if the pairing is successful, otherwise proceeding to step S3;
step S2: wirelessly connecting the shock absorber module 1 and the controller 4 and proceeding to step S4;
step S3: re-pairing the shock absorber module 1 and the controller 4 until the pairing is successful and proceeding to the step S2;
step S4: detecting the connection status between the shock absorber module 1 and the controller 4 at any time, proceeding to step S5 if the connection status is connected, otherwise returning to step S3;
step S5: detecting whether the automatic button 50 of the controller 4 is pressed, proceeding to step S6 if the automatic button 50 is pressed, otherwise proceeding to step S7;
step S6: the shock absorbing module 1 executing an automatic shock absorbing mode 120; wherein the shock absorber module 1 automatically senses the vibration of the bicycle and automatically adjusts the damping of the bicycle shock absorber 3;
step S7: the shock absorbing module 1 executing a manual shock absorbing mode 121, wherein the user adjusts the damping of the bicycle shock absorber 3 according to riding conditions; and
step S8: detecting whether the automatic button 50 of the controller 4 is pressed again, the shock absorbing module 12 continuing to execute step S6 if the automatic button 50 is not pressed again, otherwise the shock absorbing module 12 returning to proceed step S7.
